(19) United States
(12) Patent Application Publication
(10) Pub. No.: US 2009/0013598 A1
(43) Pub. Date: Jan. 15, 2009

(54) Device for the Cultivation of Plants in Vase and Earth, With Reduced Necessity of Maintenance and Irrigation

(76) Inventor: Attilio Mileto, Suna (IT)

Correspondence Address: WENDEROTH, LIND & PONACK, L.L.P., 2033 K STREET N. W., SUITE 800, WASHINGTON, DC, 20006-1021, US

(21) Appl. No.: 12/087,201

(22) PCT Filed: Jan. 30, 2007
(86) PCT No.: PCT/IB2007/000222

§ 371 Date: Sep. 19, 2008

(30) Foreign Application Priority Data
Jan. 30, 2006 (IT) VB2006A000001
May 3, 2006 (IT) VB2006A000008

(51) Int. Cl. A01G 27/02; A01G 29/00

(52) U.S. Cl. 47/48.5; 47/79

(57) ABSTRACT

Device (10, 110, 210, 310) for the cultivation of plants, of a type comprising at least one bag, (18) containing a drainage substance (20) and an absorbent substance (20a), able to retain and accumulate water; said bag (18) may also contain a fertilizing substance. The invention also refers to a bag (18) for the cultivation of plants of the aforesaid type, to be used with specifically designed containers, generic pots and planters, or in open ground.

### FIELD OF APPLICATION

The present invention refers, in its more general aspect, to a device for the cultivation of plants (herein after known as “device”) which can resolve common problems related to the maintenance and correct cultivation of plants grown indoors or outdoors. The invention also refers to a small bag which aids gardening, and can be deposited in pots or in the ground.

### PRIOR ART

It is recognized that in order to successfully grow plants in pots, the potting soil/compost must be well drained. The methods normally used for ensuring drainage of the potting soil consist in placing a few potsherds over the drainage hole(s) located on the bottom of the container, and covering them with a drainage layer, about 2-5 cm. thick, consisting of stones or pebbles, pearlite grains, vermiculite grains, evergreen or oak leaves, etc.

The drainage layer is then covered with a baffle or filtering layer consisting of nylon net, glass wool gauze or any material able to delay the occlusion of the drainage layer and of the drainage hole due to the particles of potting compost, which are carried downwards by the irrigation water and gravitational force.

Before positioning the plant, it is advisable to add a layer of organic fertilizer and a layer of potting soil mixed with sand so as to improve the performance of the underlying drainage layer.

The application for European license no. EP 1702506, in the name of the present Applicant, describes a drainage system for the cultivation of plants, which comprises a specifically designed bag, realized in geotextile fabric, containing granules of drainage material, intended to facilitate the correct drainage of the irrigation water. Use of this bag eliminates the necessity of all of the above-mentioned materials traditionally needed for the drainage of plants grown in pots (e.g. potsherds, pearlite, pebbles, felt etc.), due to the fact that said bag already contains the correct amount and composition of drainage material.

Along with other advantages, using the bag briefly described above for growing plants in pots, can solve the problem of watering and maintenance of plants in the event that they cannot be cared for over an extended period of time.

### SUMMARY OF THE INVENTION

The technical problem that is the basis of the present invention was to devise and realize a device for cultivating plants, designed to limit the required frequency of watering and to simplify fertilization. These problems are solved with the present invention, a pot, or device, equipped with a bag containing both drainage and absorbent material, able to retain and accumulate water.

The absorbent substance is in the shape of grains, granules, crystals or similar with said draining and absorbent substances constituting a single draining/absorbent substance, e.g. polyacrylamide-(sodium acetate-CHCHCONH2) or any other organic/inorganic material with equivalent characteristics and behaviour. Further characteristics and advantages of the device for the cultivation of plants according to the present invention will be evidenced in the following description of preferred embodiments, given as indicative and non-restrictive, with reference to the attached drawings.

### SHORT DESCRIPTION OF DRAWINGS

FIG. 1 schematically represents a longitudinal section view of first preferred embodiment of a device for the cultivation of plants, according to the present invention.

FIG. 2 schematically represents a perspective view of one component (bag) of the device of FIG. 1.

FIG. 3 schematically represents a longitudinal section view of the portion of FIG. 2.

FIG. 4 schematically represents a perspective view of a second embodiment of device, according to the present invention.

FIG. 5 schematically represents a longitudinal section view of the device of FIG. 4.

FIG. 6 schematically represents a perspective view of a component (bag) of the device of FIG. 4.

FIG. 7 schematically represents a longitudinal section view of another component (covering) of the device of FIG. 4.

FIG. 8 schematically represents a perspective view of a third embodiment of device, according to the present invention.

FIG. 9 schematically represents a perspective view of a component (bag) of the device of FIG. 8.

FIG. 10 schematically represents a perspective view of the reverse side of component (bag) of FIG. 9.

FIG. 11 schematically represents a perspective view, to magnified scale, of the component (bag) of FIGS. 9 and 10 and an ulterior component (support for fertilizing product) of the device for the cultivation of plants of FIG. 8.

FIG. 12 schematically represents a perspective view, to magnified scale, of the device of FIG. 8, in which the ulterior component of FIG. 11 (support for fertilizing product) is associated to the component (bag) of FIG. 9.

FIG. 13 schematically represents another perspective view of reverse side of the device of FIG. 8.

FIG. 14 schematically represents an ulterior perspective view, to magnified scale, of the device of FIG. 13, in which the component of FIG. 11 has been extracted from the component of FIG. 9, operating from the bottom of the same device.

FIG. 15 schematically represents a perspective view of a third preferred embodiment of the said device, according to the present invention.

### DETAILED DESCRIPTION OF A PREFERRED EMBODIMENT OF THE INVENTION

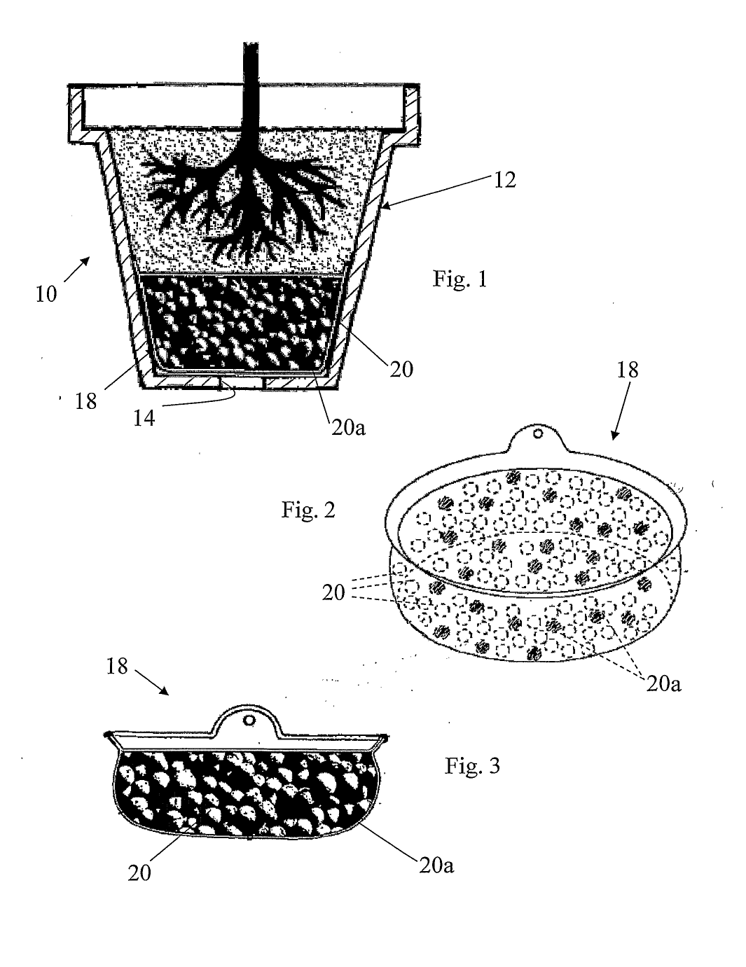

With reference to FIGS. 1, 2 and 3, is shown a first preferred embodiment of a device for the cultivation of plants according to the present invention and indicated altogether with 10. As an example, device 10 is realized in terracotta, plastic, concrete, metal, wood, etc.

The device 10 is of type comprising an open covering 12 equipped with a substantially plain bottom 13. In the preferred embodiment illustrated in the said figures, bottom 13 is supplied of a drain-water hole 14 for water evacuation. In general terms, more (than one) drain holes can be previewed.

According to the present invention, the said device 10 comprises to its inside a sealed bag 18 who contains a drainage material 20 and an absorbent material 20a, liable to water retention and water accumulation.

In particular, the bag 18 is positioned above bottom 13.

Preferably, the drainage material 20 is in the form of grains (or crystals) in plastic, expanded clay, expanded polystyrene, pearlite, vermiculite, etc, or of sand, gravel or pebbles, or still under shape of potsherds or pumice stone or other equivalent materials.

According to an aspect of the present invention, the said absorbent material 20a is in the form of grains, crystals or similar. As an example the said absorbent substance 20a is in the form of natural clay grains and/or bentonite and/or peat and/or humus and/or other material with equivalent characteristics and/or performances.

Preferably, the aforesaid drainage substances 20 and absorbent 20a enclosed in said bag 18 are at the same time draining and absorbent, so that they are a unique “drain-absorbent” substance, as an example polyacrylamide-sodium acetate (polyacrylamide polymers) or other organic or inorganic material with equivalent characteristics and behaviour. The drain-absorbent crystals, if put in contact with water, absorbs it increasing their volume slowly, and they may succeed to absorb, in the example of polyacrylamide crystals, in a time of sixty minutes approximately, until to 450 times their weight in water.

When caught up the imbibition's limit, the aspect and the behaviour of drain-absorbent crystals radically changes: the hydrated mass assumes a gelatinous aspect, although the single crystals however remains separated from the others, the still circulating water is rejected, and let free to percolate for gravity. Such mutagen characteristic behaviour confers to crystals e.g. of polyacrylamide, synthetic substance, the wished characteristics of “drain-absorbing”, that the bag 18 adequately takes advantage of and values.

The water therefore accumulated then is gradually released, according to needs of the hosted plant and of its radical apparatus, that is indirectly in contact with drain-absorbent crystals, e.g. polyacrylamide, but through the bag 18, that is realized by a cloth of woven material or geotextile fabric or “non woven” fabric, it remains physically detached from it. The “water crystals” are available on the market with several trade denominations (Water Crystals®, Grain d'eau®, etc). In particular, the crystals of polyacrylamide are a non toxic product and they do not involve risks for the animals.

Preferably, the bag 18 is realized through the connection of two cloth layers, permeable to all liquids, in woven material or geotextile fabric or “non woven” fabric (and therefore in organic, inorganic or vegetal material). The said cloth layers are sewn between them (manually and/or mechanically) or heat sealed or glued, substantially in quilted way; inside this shell is maintained the drainage material 20 and the absorbent material 20a, that is a “drain-absorbent” substance. The above described geotextile cloth (as possible alternative to woven or “non woven” fabrics), is available on the market with several names, e.g. Terram®, Polyfelt®, Stabilenka® etc. Such material is permeable to liquids material, imputrescible, non-toxic, resistant to chemical agents, unattackable by bacteria, fungus, etc.

The advantages deriving from its application in order to realize the bag 18 are due, beyond to its permeability to water and to its imputrescibility, also and above all both to its impenetrability to soil, used like substrate by the hosted plant, and to the endings of the radical apparatus.

That involves the following remarkable advantages:
Perfect and long-lasting separation of the drainage material, enclosed in the bag, from the potting mould: the soil will keep the correct granulometric composition, thereby preserving optimal physical and chemical characteristics;
Long-lasting effectiveness of the drainage system;
Due to the geotextile characteristics of the bag, the root system of the plant cannot penetrate the drainage bag. The separation of the drainage bag from the potting mould block will therefore be easy, quick and safe, without jeopardizing the conditions of the root system;
Possibility to re-use more times over the same bag in following repottings.

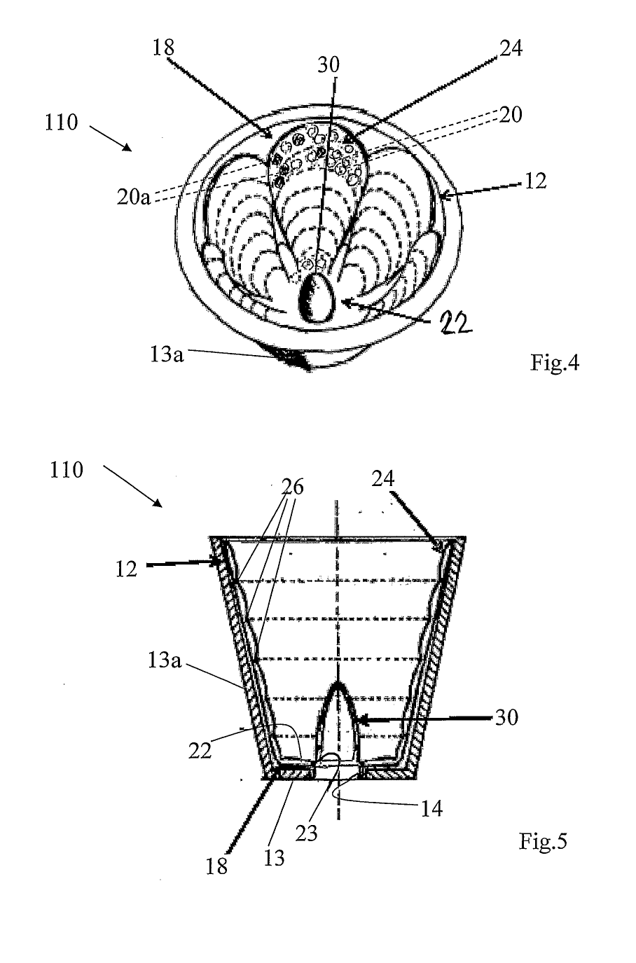

In FIGS. 4 and 5 is represented a second embodiment of a device for the cultivation of plants, according to the present invention and altogether with 110. In FIGS. 4 and 5, to identical structural elements or functionally equivalent to those of device 10 of FIGS. 1-3 above described, are attributed the same reference numbers and they will be no further described.

FIG. 5 describe in cross-sectional section the covering 12 with bag 18 correctly inserted. In particular, covering 12 of illustrated device 110 is in terracotta, plastic, concrete, metal, wood, etc. and, in the sample of this second embodiment, it comprises a bottom 13 substantially circular and one substantially truncated-conical lateral surface 13a, bottom 13 substantially constituting the lower base of the truncated-cone defined by the lateral surface 13a.

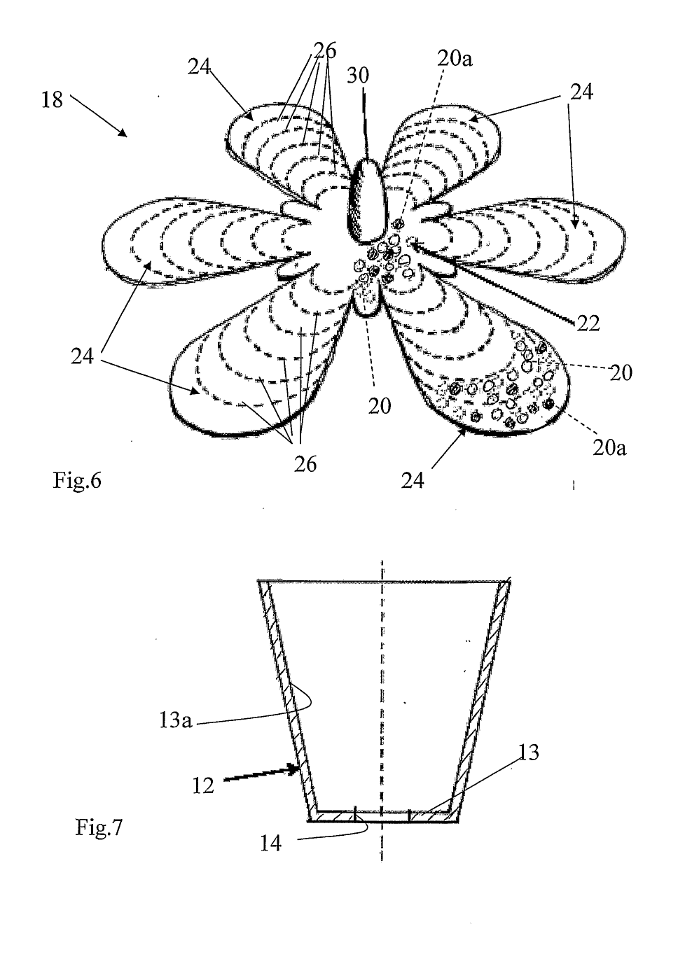

Preferably, as it is shown in the examples of FIGS. 4, 5 and 6, the bag 18 comprises a central portion 22 substantially circular, preferably with dimensions substantially equal to those of bottom 13 of the covering 12, plus several radial portions 24 (in the FIG. 6 radial portions 24 are in number of six): these portions extends radially in “petal” shape from said central portion 22.

As shown in FIG. 4, the aforesaid “flower shape” conformation of bag 18 of FIG. 6 is adapted to be utilised in a truncated-conical covering 12: the central circular portion 22 is positioned over the circular bottom 13 of covering 12, while radial portions 24 lies down on truncated-conical lateral surface 13a of covering 12.

As far as radial portions 24, their radial development is sufficient to allow the wrapping of great part of the lateral surface 13a of the covering, preferably until the upper edge of the covering.

Preferably, the radial portions 24 are perimetrally ended by a plastic ribbon (ribbon not represented in figures because conventional).

Favourably, because radial portions 24 might be adapted to truncated-conical shape of several dimensions, bags 18 are produced with radial portions 24 extended, so that they can be shortened until the wished measure removing (cutting it off) a part of extremity of the radial portions 24.

In order to make that, after the removal of the extreme parts of radial portions 24, the contained “drain-absorbent” substance in bag 18 cannot come out, in every radial portions 24 are previewed several seams 26 (or heat seam or glued seam) of the two cloth layers, being the said seams/heat seams/glued seams 26 substantially cross-sectional regarding the radial extension of radial portions 24 and defining a plurality of enclosed “shells” that contain the “drain-absorbent” substance. In this way, it's possible to vary the total dimension of radial portions 24 simply removing one or more orders of “shells”, consequently reducing the external perimeter of bag 18. Obviously, using a device 110 that doesn't have a truncated-conical shape, the central portion 22 and radial portions 24 can have other geometric shapes, according to covering 110 in which bag 18 is placed. In particular, the radial portions can be connected between them to form a unique annular portion.

Favourably, the bag 18 can be covered, on the side toward the internal surface of covering 12 of device 110, by one layer of waterproof material, e.g. one layer of flexible plastic or vegetal material. In particular, the impermeable layer may cover, in partial or total measure, the side of bag 18 destined to come in contact with the lateral surface 13a of covering 12 of device 110 within bag 18 is inserted, to the aim of maintain the water balance of the “drain-absorbent” substance contained in it; in fact such balance could be compromised if the covering is produced by porous material (clay, concrete, tuff etc).

Alternatively, the bag 18 is realized through connection of one cloth layer, permeable to the liquids, and one impermeable layer, positioned on the side of bag 18 destined to rest in contact with the internal surface of the said covering 12 of device 110. In agreement with ulterior shapes of realization of the invention, the device for the cultivation of plants comprises to inner one series of shells and mobile parts functionally equivalents, either capable of carrying out the same functions, with respect to the bag described above.

In particular, the described bag may comprise only one layer cloth, permeable to liquids, which is associated to the inner side of device's covering, and between the said inner covering and said cloth is present a drainage material and/or an absorbent material, susceptible of retention and water accumulation. Preferably, according to this last preferred embodiment, the cloth layer is not removable from the covering, and the inner wall of the covering is impermeable to water.

According to an ulterior aspect of the present invention, in the said bag 18 is removably positioned a container 30 for a fertilizing product. As an example, the container 30 can be fixed over of bag 18 by a Velcro® reclosable fastener. In the preferred example illustrated in FIGS. 4-6, the said container 30 is removably engaged in a pass-through opening 23 which is provided in the central portion 22 of the said bag 18. In particular, the opening 23 is positioned to the centre of portion 22 and is preferably circular.

Preferably, the container 30 is substantially cylindrical; it extends toward the inner core of the device, and is structured for the gradual (slow) release of the fertilizing product. In particular, the container 30 is micro-perforated or covered by a non-woven fabric (or another material with similar characteristics), in order to permit the release of the fertilizing material in the potting mould with which the device is filled up.

Preferably, the container 30 is made accessible through the drain-water hole 14 provided on device's bottom, so to permit its eventual refilling with new fertilizing product.

In particular, the container 30 is equipped with a reclosable opening trough which is possible to refill it with a (new) fertilizing product, and the said opening is preferably provided on bottom of device, in such way that said reclosable opening is always accessible from the outside of the device, also when it's filled up of soil, passing through the drain-water hole 14 of the device.

In particular, the container 30 is susceptible of being opened and reclosed in correspondence of the aforesaid opening via a zipper or a Velcro® fastener or other equivalent system (conventional and therefore not shown in the figures), and the introduction of the fertilizing material can be executed from the bottom of the device, without jeopardizing the radical apparatus of hosted plant, because the said pocket is accessible simply tilting the device 110, e.g. of approximately 30 degrees.

Favourably, the fertilizing product is organic or mineral, and slow-release type. The fertilizing product is in the shape of grains, rods, cones, rings or other geometric conformations able to distribute in potting soil the nourishing substances in a gradual and controlled measure, in order to make possible the correct and intuitive dosage of the correct amount of fertilizing material by the users, according to the dimensions of the device or device and/or the effective requirements of the hosted plant.

The fertilizer/nourishing type may be varied on base of previewed use, e.g. for use with acidophil plants the container 30 is filled up with a compatible fertilizing substance.

In particular, FIG. 7 shows the covering 12 of device 110, according to the invention, is equipped with a drain-water hole 14 which is circular and has an increased diameter regarding to the current standardized dimensions of drainage holes present in truncated-conical pots available in commerce. Such norm derives both from consuetude, both from the objective uselessness to provide openings with a diameter higher than 2.5 cm. In fact the current methods of cultivation in pot would have not the possibility to regulate the outflow of solid material (soil, drain material etc.) through holes with higher dimension/diameter.

The said limitations recommends instead, when the dimensions of the pot raises up, to make correspond a greater number of drainage holes, distributed in variable ways on bottom or side of the same pot, but maintaining the maximum unitary aforesaid dimension (diameter 2.5 cm.).

The diameter of the drain hole 14 of covering 12 of device 110 according to the invention is preferably comprised between 30 and 100 millimeters.

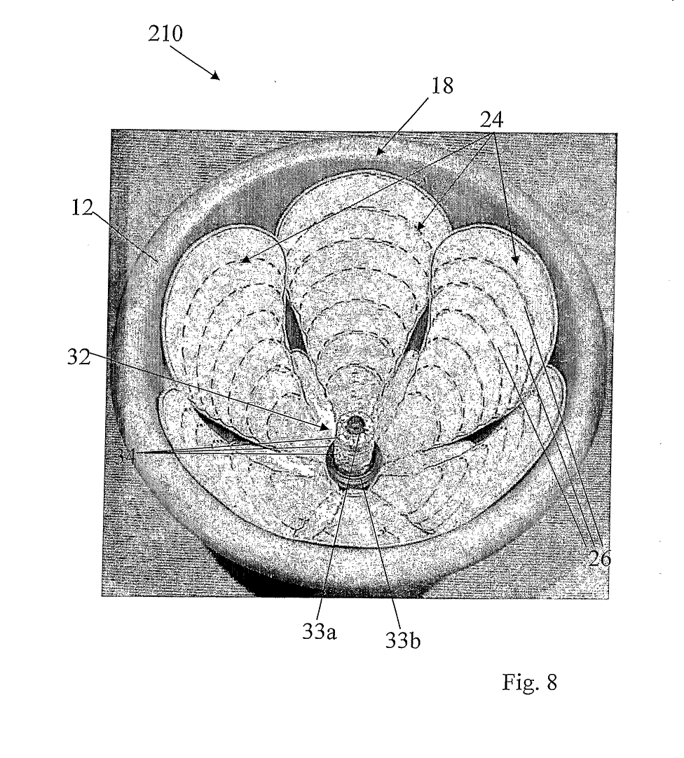

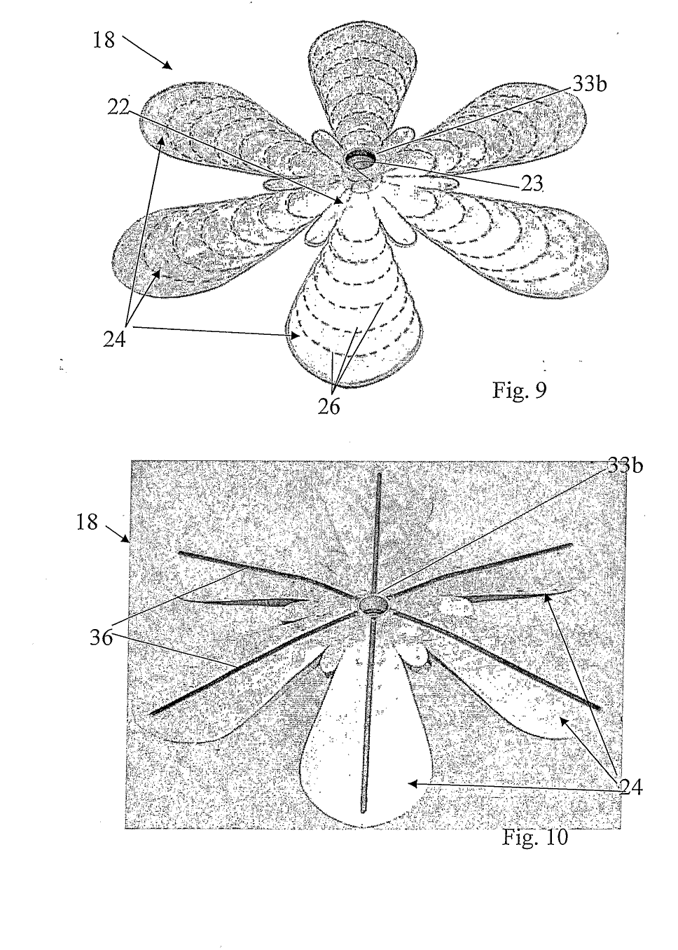

In FIGS. 8-14 is shown a third embodiment of a device for the cultivation of plants, according to the present invention and altogether indicated with 210. In FIGS. 8-14, to identical structural elements or functionally equivalent to those of device 110 of FIGS. 4 and 5 described above, are attributed the same reference numbers and they will be no further described.

In this embodiment, the container 30 of FIGS. 4, 5 and 6 is replaced by a support 32 for a fertilizing product. In other words, inside the bag 18 of device 210 is removably positioned a support 32, comprising a substantially cylindrical bar 33a, on which is worn a fertilizing product, preferably in the shape of a plurality of rings 34 or tablets, so as to be easily dosed according to the dimension of covering 12 of device 210. In particular, the support 32 comprises a substantially cylindrical sleeve 33b, into which a substantially cylindrical hinge 33c may be inserted.

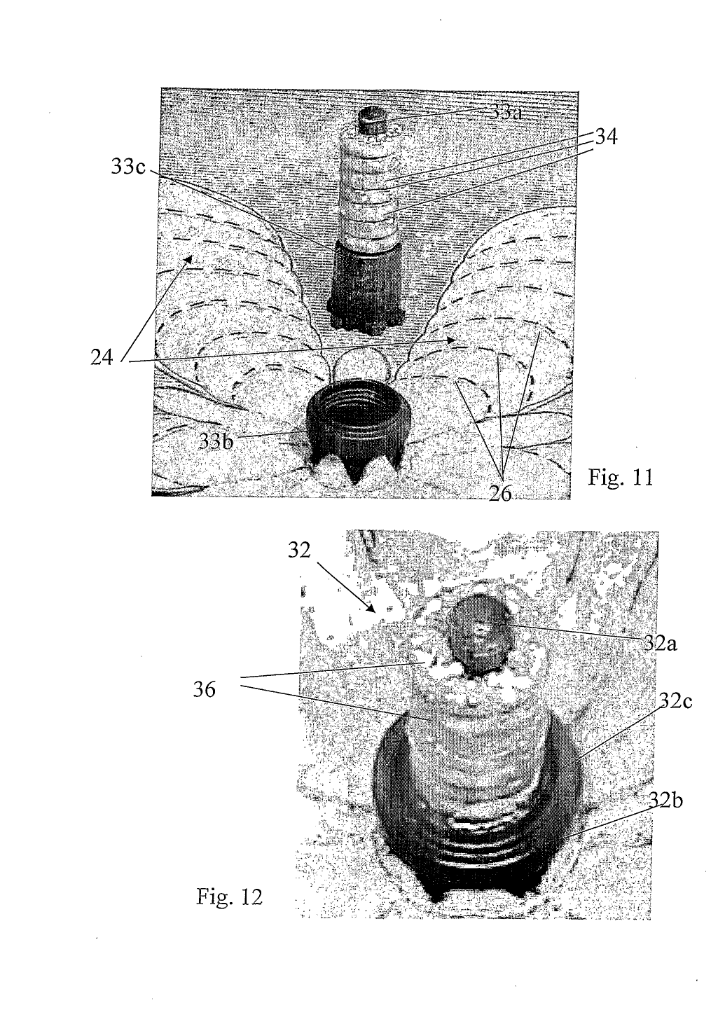

More exactly (FIGS. 11 and 12), said sleeve 33b is removably engaged in a pass-through opening 23 in the central portion 22 of the said bag 18, and the bar 33a is placed to one extremity of said hinge 33c, so as it extends toward the inner core of covering 12 of device 210. As shown in FIGS. 11 and 12, the rings 34 have an external dimension which is equal or inferior to the external dimension of the hinge 33c.

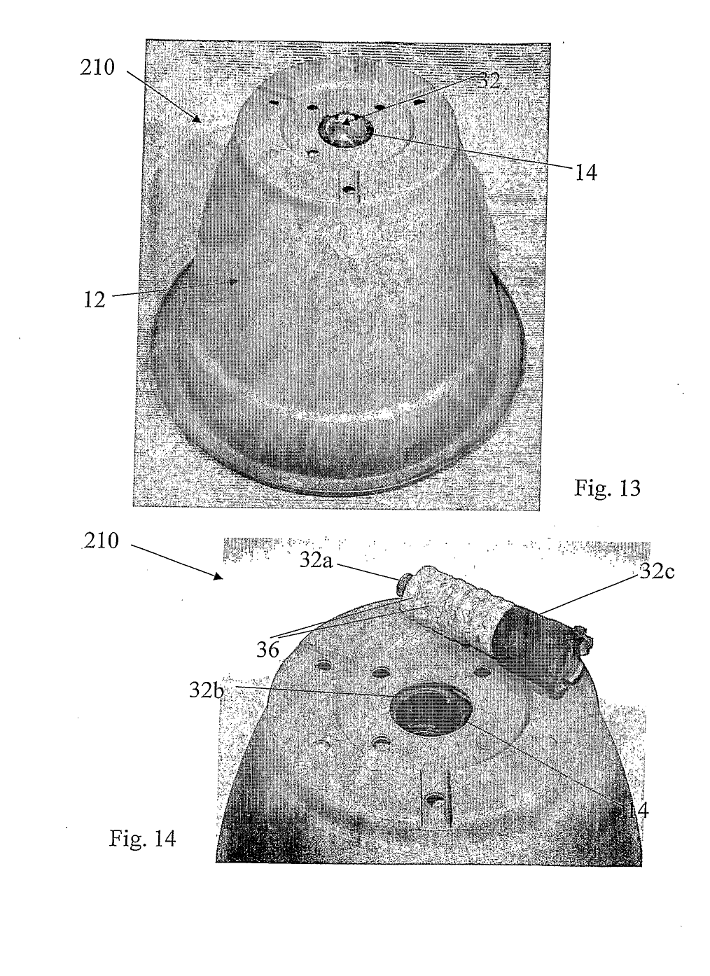

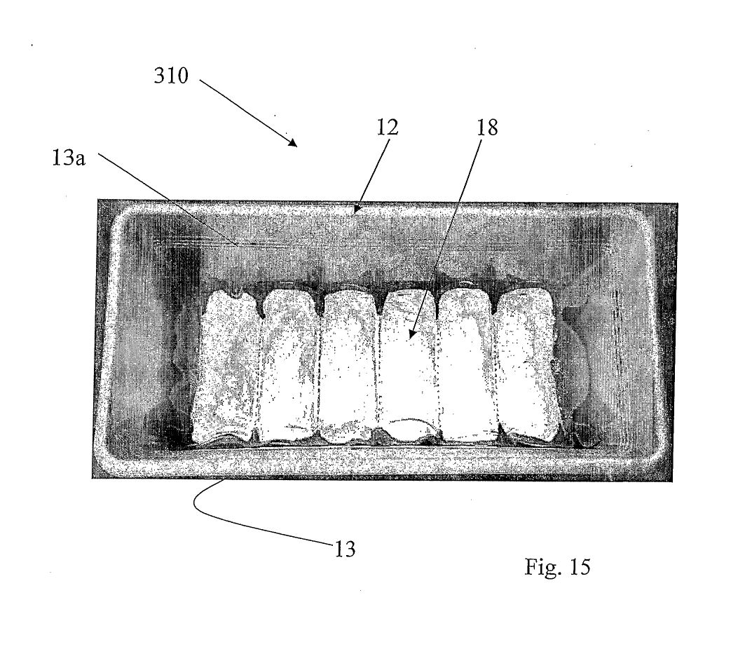

The aforesaid support 32 is movable from the central portion 22 of bag 18 to permit the refill of the fertilizing product. In particular, the inner cavity of the sleeve 33b has equal or smaller dimension with respect to that of the drainage hole 14 of device 210, so that the hinge 33c bringing the bar 33a is extractable from the bottom of device 210, operating through the drainage hole 14 of the device 210 (FIGS. 13 and 14).

In an alternative, the sleeve 33b of support 32 is initially fixed in correspondence of the drainage hole 14 of device 210, and the bag 18 is then subsequently placed around the same sleeve 33b in correspondence of pass-through opening (23), so that it can be easily replaced.

Obviously, as the longitudinal dimensions of covering 12 of device 10, 110 or 210 (or balcony cassettes, bowls etc) increase, the number of drainage holes (which in device 210 or 110 according to the present invention assumes also the function “of fertilizer refilling holes”) increase, and consequently the number of bags 18 will be proportionally increased, so as to assure the necessary amount of fertilizing substances, as well as a sufficient water reserve and a correct water-drainage degree of the plants grown in said coverings.

In other words the device 10, 110 or 210 may be equipped of a plurality of bags 18.

Through the opening of container 30, accessible from the outside of the device through the drainage hole 14 of covering, or rather thanks to support 32 with the bar 33a, which is removable from the central portion 22 of bag 18, the restoration of the nourishing function is allowed in every moment, easily operating though the inferior side of device: after having tilted the device, the container 30 is approached extracting the sleeve 33b of support 32 so to recharge the fertilizer. In particular, replacing the fertilizer comprised in the container 30, or rather refilling the bar 33a of support 32 with fertilizer rings 34 or tablets, the nourishing requirements of the plant for the entire successive year are guaranteed.

Favourably, the bag 18 has a flexible structure in plastic or vegetal material so that it spontaneously discloses itself and can be lean on top of covering 12 of device 10, 110 or 210, then can be pushed toward the bottom of the device's covering and centered on the “drain/fertilizer refilling” hole. At this point the potting/repotting operation may be completed as usual.

In FIG. 10 is shown the way like radial portions 24 of bag 18 of device 210 (that is also of device 110) may be equipped, on the side destined to be faced toward the covering 12 of device 210 or 110 respectively, of a plurality of radial ribs 36 in flexible plastic material, which departs from the sleeve 33b of support 32. The said radial ribs 36 reinforces the radial portions 24 and facilitates the correct positioning of bag 18 in covering 12 of device 210 or 110 respectively.

Devices 10, 110 or 210 according to the invention, may also be equipped with automatic surveillance and warning systems, able to detect the degree of humidity of the substrate (hygrometer), the PH level of the soil (acidity detector), and the degree of sun irradiation of the hosted plant (photometer/luxmeter) and signal any sufferance on the part of the plant and/or potentially injurious situations, so that problems can be effectively and timely corrected and/or to eliminated before any damage is done.

It's noticed that the bag 18 may also contain a fertilizing substance, especially if the bag 18 isn't equipped with the container 30 or of support 32 for the fertilizer.

Moreover, the bag 18 may assume different conformations so as to facilitate shipping, distribution and commercialization. For example, the bag 18 of devices 110 or 210 may be collapsible (e.g. radial portions 24 can be refolded towards the axis of symmetry of container 30 or support 32, and such operation is simplified by the presence of the flexible radial ribs 36), or composed by several elements of identical shape and dimension, assembled so as to rotate around the symmetrical axis constituted by the vertical axis of device 110 or 210, with the aim of reducing the size of bag 18 when not in use.

The invention refers both to the bag 18 for the cultivation of plants described above, as well as to the aforesaid covering 12 described above, which is suitably structured in order to contain the aforesaid bag, that is destined to be removably engaged to a container or a support for a fertilizing product, such as the container 30 or support 32 described above.

In FIG. 15 is shown a fourth embodiment of the device for the cultivation of plants, according to the present invention and altogether with 310. In FIG. 15, to identical elements or structurally equivalent to those of device 10 of FIGS. 1-3 described above, are attributed the same reference numbers and will therefore not be described again.

In this case, the covering 12 assumes a substantially parallelepiped shape, that is a so-called “balcony flower box or planter”, and comprises a substantially rectangular bottom 13. Bag 18 of device 310 differs from the bag 18 of FIG. 1 in its shape only, which in this case has a substantially rectangular perimeter, preferably with dimensions substantially equal to those of bottom 13 of covering 12 of device 310. Alternatively, the bag 18 of device 310 may include ulterior portions that are leaned on the inner lateral surface 13a of covering 12 of device 310 It was discovered that the bag described above can also be used for the cultivation of plants grown outdoors in the ground, in the absence of a pot encircling the roots of the plant: in fact, the absorbent substance contained inside the bag facilitates a continued supply of water even in particularly arid or barren conditions (in this case, is also possible to equip the bag with a container or a support for a fertilizing product, as the container 30 or support 32 described above).

From the previous description it derives in obvious way that the device, and respectively the bag for the cultivation of plants according to the invention, resolves the technical problem and achieves numerous advantages, first of which resides in the fact that the irrigation requirements of the hosted plants are significantly reduced. Test experiments has shown that, in normal conditions, an abundant watering every 7/10 days is sufficient for the greater part of the houseplants and ornamental plants, and moreover plants maintain optimal vital conditions until to 14 days from said irrigation.

The use of the above drainage bag includes the following advantages:
Pursuing and storing all required material to carry out the drainage of plants in pots (shreds, pearlite, pebbles, felt, etc.) will no longer be necessary; the bag, according to the invention, contains all that is needed to obtain good drainage for any type of plant cultivated in a pot or in a flowerbox, regardless of the material the container is made of (clay, plastic, cement, metal, wood or otherwise);
Re-potting operations are facilitated, and made easier, faster, more efficient and longer lasting. It will no longer be necessary to know what drainage material is necessary, how much of it is needed at the bottom of pots or boxes, how it should be positioned and in what order. One bag will be enough for each pot (with the size proportionate to the container) or, in the case of flower boxes, planters and containers, with several drainage holes, it will be necessary to use as many bags as the number of cavities located on the bottom of the container thereof (in case of containers with several holes close together, one bag may be enough);
The materials contained in the bag, will remain perfectly separated from the potting compost; in the case of re-use, the potting compost will maintain its correct granulometric composition, thereby preserving optimum physical/chemical characteristics;
The root system of the plant cannot penetrate inside the bag 18, thanks to the characteristics of the material, for example geotextile, of which said bag is made of. At the time of re-potting, the separation of the bag from the block of potting compost will therefore be easy, fast and safe, without jeopardizing the conditions of the root system;
The necessity of adding fertilizing materials, which is often neglected or forgotten, is reduced to a once-a-year operation;
Plants can be sold ready for market thanks to the bag, according to the invention. Its generalized use can drastically diminish plant mortality, and allows delivery to the purchaser plants ready to sell, avoiding the forced re-potting into containers fit for apartments. In fact, nursery pots do not guarantee correct conditions for root systems: non-existent water-drainage, roots left to soak in the water of the saucer, no oxygenation, excessive temperatures, spillage of soil from the drainage holes, etc. are all conditions that impede the purchase of live plants, reducing sales to unnatural, forced purchases
Water is stored and maintained at a proper depth for the plants, while overflow and spillage are avoided;
Water stagnation in the saucer, which on balconies and terraces can become a breeding ground for bug/insect larva, is avoided; in particular the use of the bag according to the invention, keeps those conditions conducive to the reproduction of hemophiles (mosquitoes) from forming;
In the event of containers lacking drainage holes, the bag, according to the invention, absorbs excess liquids, thus preventing unhealthy stagnation;
The bag, according to the invention, absorbs any chemical elements added to the irrigation water. It withholds therefore all fertilizing solutions, bactericides, fungicide etc. and it returns them to the roots as required by the plant. It prevents these substances from ending up in the saucer and stagnating there and also keeps pets from accidentally drinking contaminated water;
In the greenhouse, the bag according to the invention reduces the frequency of watering, avoiding the need to recover the irrigation water, and maintains the optimal level of fertilizer in every pot without using liquid fertilizers, which could flow into the sewage system or into the ground, eventually polluting the water-bearing stratums and subsequently rivers, lakes and seas;
The bag, according to the invention, can be used immediately, starting with the production phase in the nursery, due to the facility with which it can be inserted into containers, manually or also in the presence of automated operations;
In the greenhouse, the bag, according to the invention, eliminates the necessity of maintaining the base of the containers constantly humid, thus avoiding the consequent waste of water caused by evaporation;
At the moment of re-potting, the effectiveness of the nourishing function can be reintegrated simply by opening the fertilizer container and replacing its contents;
The device, according to the invention, allows for the re-integration of the nourishing function at any time, with easy access from the bottom of the pot;
The bag, according to the invention, facilitates the extraction of the root ball, even from containers with an irregular or rough surface, thanks to the conformation of the bag that lines the inner walls of the container. When re-potting, it is not necessary to subject the pot to shaking or hitting that could be potentially harmful to the integrity of the pot, as well as to the plant;
In the greenhouse, as in the house, the bag, according to the invention, completely wraps the root ball with a proper “water mattress” that protects the root system from excessively high or low temperatures;
The mechanical expansion and contraction of the bag, according to the invention, keeps the soil constantly in motion, thus continuously aerating and enriching it with oxygen;
The bag, according to the invention, completely covers the internal surface of clay vessels, reducing the possible formation of saltpetre spots on the external surface, with appreciable aesthetic advantages.

Obviously, a qualified technician can carry out various functional modifications, adaptations, substitutions of elements with equivalents of the device for the cultivation of plants above described, in order to satisfy particular and contingent requirements without departing from the protected range of the present invention, as defined by the following claims. It is to be understood, therefore, that the invention should be regarded as encompassing not only the subject matter literally defined by the claims which follow, but including any mechanical equivalents thereof.

1. Device (10, 110, 210, 310) for the cultivation of plants, characterized by incorporating at least one bag (18) containing a drainage substance (20) and an absorbent substance (20a), able to retain and accumulate water.

2. Device (10, 110, 210, 310) according to claim 1, characterized in that said absorbent substance (20a) is in the shape of grains, granules, crystals or equivalent.

3. Device (10, 110, 210, 310) according to claim 1, characterized in that said drainage (20) and absorbent (20a) substances comprise a single “draining-absorbing” substance.

4. Device (10, 110, 210, 310) according to claim 3, characterized in that said “draining-absorbing” substance is polyacrylamide-sodium acetate (polyacrylamide polymers-sodium acetate CHCHCONH2) or another organic or inorganic material with equivalent characteristics and behaviour.

5. Device (10, 110, 210, 310), according to claim 1, characterized in that said bag (18) is made of two connected layers of textile material, geotextile, “non woven” or similar cloth, permeable to liquids.

6. Device (10, 110, 210, 310) according to claim 5, characterized in that said layers are quilted together by being manually and/or mechanically sewn, heat sealed or glued.

7. Device (110, 210), according to claim 1, characterized in that said bag (18) comprises a round central portion (22), and a plurality of radial sections (24), which extend out into a “petal” shape from said central portion 22.

8. Device (110, 210, 310), according to claim 6, characterized in that each of the said radial sections (24), comprising two cloth layers, presents a plurality of heat-sealed or glued seams (26) and said heat sealed/glued seams (26) are cross-sectional to the extension of the radial sections (24) and so define a plurality of sluice “compartments”.

9. Device (10, 110, 210, 310), according to claim 1, characterized in that said bag (18) may be equipped, on the side destined to face towards the inner surface of the covering (10, 110, 210), with a layer of waterproof material.

10. Device (10, 110, 210, 310), according to claim 1, characterized in that said bag (18) consists of a cloth layer, permeable to liquids, and a second impermeable layer.

11. Device, according to claim 1, characterized in that said bag comprises one cloth layer only, permeable to liquids, that lies against the inner surface of the covering. Between said inner surface and said cloth layer are interposed the said drainage substance and the said absorbent substance.

12. Device (110, 210), according to claim 8, characterized in that inside said bag (18) is positioned a removable container (30) to hold fertilizing products.

13. Device (110, 210), according to claim 12, characterized in that said container (30) can be removed through an opening (23) in the central portion (22) of said bag (18).

14. Device (110, 210), according to claim 13, characterized in that said container (30) is cylindrical, and extends up into the center of the device, and is structured for the gradual release of the fertilizing product.

15. Device (110, 210), according to claim 12, characterized by the fact that said container (30) is accessible through the drainage hole (14) in said device, for eventual refilling with new fertilizing product.

16. Device (210), according to claim 8, characterized by the fact that in said bag (18) is positioned a removable support (32) comprising a (33a) cylindrical bar, on which fertilizing products, preferably in the shape of a plurality of rings (34) or tablets, are placed.

17. Device (210), according to claim 16, characterized by the fact that said support (32) comprises a cylindrical sleeve (33b) into which a cylindrical hinge (33c) may be inserted, to hold said bar (33a).

18. Device (210), according to claim 17, characterized by the fact that said sleeve (33b) of support (32) is positioned in correspondence to both the drainage hole (14) of said device (210), and the opening (23) of said bag (18).

19. Device (10, 110, 210, 310), according to claim 1, characterized by the fact that said bag (18) also contains a fertilizing substance.

20. Device (10, 110, 210, 310), according to claim 1, characterized by the fact that said drainage substance (20) is granular in shape and can be plastic, expanded clay, expanded polystyrene, pearlite, vermiculite or any other equivalent material, or may consist of sand, gravel or pebbles, or be in the shape of potsherds or pumice stones or other equivalent material.

21. Device for the cultivation of plants, comprising a bottom (13) equipped with a drainage hole (14), characterized in that said hole (14) is circular and has a diameter between 30 millimeters and 100 millimeters, in that it is destined to be used to remove container (30) or support (32) for a fertilizing product.

22. Bag (18) for the cultivation of plants, characterized in that it contains a drainage substance (20) and an absorbent substance (20a), able to retain and accumulate water, that is, a “draining-absorbing” substance, according to claim 4.

23. Bag (18), according to claim 22, characterized in that it also contains a fertilizing substance.

24. Bag (18), according to claim 22, characterized in that said absorbent substance (20a) is in the shape of grains, granules, crystals or equivalent.

25. Bag (18), according to claim 22, characterized in that said drainage substance (20) and absorbent substance (20a) is a single “draining-absorbing” substance.

26. Bag (18), according to claim 22, characterized in that said “draining-absorbing” substance is polyacrylamide sodium acetate (polyacrylamide polymers-sodium acetate CHCHCONH2) or any other organic or inorganic material with equivalent characteristics and behaviour.

27. Bag (18), according to claim 22, characterized in that said bag (18) is made of two layers, permeable to liquids, in geotextile, woven or not woven cloth, or similar material.

28. Bag (18), according to claim 27, characterized by the fact that said cloth layers are quilted together by being manually and/or mechanically sewn, heat sealed or glued.

29. Bag (18), according to claim 22, characterized by the fact it is comprised of a circular central portion (22) and a number of radial sections (24), which extend out into a “petal” shape from said central portion 22.

30. Bag (18), according to claim 28, characterized in that on the two cloth layers of each radial section (24) a number of heat sealed or glued seams (26) have been added with said heat-sealed/glued seams (26) being cross sectional to the extension of the radial sections (24), thus defining a plurality of sluice “compartments”.

31. Bag (18), according to claim 22, characterized in that said bag (18) is covered, on the side facing the internal surface of device (10, 110, 210, 310), with a layer of impermeable material.

32. Bag (18), according to claim 20, characterized in that in said bag (18) is positioned a removable container (30) for a fertilizing product.

33. Bag (18) according to claim 32, characterized by the fact that said container (30) is removed through an opening (23) in the central portion (22) of bag (18).

34. Bag (18), according to claim 22, characterized by the fact that in said bag (18) is positioned a removable support (32) comprising a cylindrical bar (33a) on which a fertilizing product, preferably in the shape of a plurality of rings (34) or tablets are positioned.

35. Use of one bag, according to claim 22, inside a container for the cultivation of plants.

36. Use of one bag, according to claim 22, in open ground after removal of a sufficient layer of soil necessary for planting.

37. Use of a plurality of bags, according to claim 22, that have been joined together to form a roll or ribbon-like system in open ground, after the removal of a sufficient layer of soil necessary to accommodate said bags and deposit them to the required depth.
